(19) United States
(12) Patent Application Publication
(10) Pub. No.: US 2007/0045189 A1
(43) Pub. Date: Mar. 1, 2007

(54) Acid mine water demineralization methods

(75) Inventors: Frederick W. Lichtner, Richboro, PA (US); Robert A. Hendel, Chalfont, PA (US); David M. Polizzotti, Yardley, PA (US)

Correspondence Address: WEGMAN, HESSLER & VANDERBURG, 6055 ROCKSIDE WOODS BOULEVARD, SUITE 200, CLEVELAND, OH, 44131, US

(73) Assignee: General Electric Company, Schenectady, NY (US)

(21) Appl. No.: 11/216,558

(22) Filed: Aug. 31, 2005

(51) Int. Cl. B01D 61/02

(52) U.S. Cl. 210/652; 210/749; 210/758; 210/804; 210/696

(57) ABSTRACT

Acid mine demineralization methods wherein the acid mine drainage is neutralized, clarified, and forwarded to a microfiltration unit. The so filtered drainage water is then forwarded to a reverse osmosis unit. The permeate from the reverse osmosis unit is characterized by reduced sulfate, silica, calcium, aluminum, iron, magnesium, and manganese levels. Additionally, improvement in reduction of total dissolved solids is noted.

### FIELD OF INVENTION

The invention pertains to methods for treating acid mine drainage wastewater to reduce dissolved and suspended particles therein to result in a product water that is suitable for discharge or for use as makeup water to a power plant or the like.

### BACKGROUND OF THE INVENTION

Acid mine drainage (AMD) water is created by surface mining, deep mining, or refuse piles when pyrite is exposed to air. Pyrite commonly occurs in mineral seams (e.g., gold, copper, coal, etc.) and in the rock layers adjacent to these seams. It is exposed to air during the mining and mineral recovery process. When pyrite interacts with oxygen and water, ferrous and ferric iron and sulfuric acid are created. The low pH of the resultant water solubilizes many undesirable heavy metal species such as iron, manganese, and aluminum as well as lead, zinc, cadmium, and mercury. In addition, the water can also include high levels of suspended solids. Often, these waters contain excessive Ca⁺² and SO₄⁻² ion concentrations that under certain conditions precipitate as CaSO₄ on surfaces that come into contact with the water.

Various approaches have been used to remediate AMD water. For example, chemicals may be added to precipitate dissolved metals contained in the water to subsequently coagulate and separate the precipitated solids from the AMD prior to mechanical filtration systems such as mixed media filters, etc.

Water reuse applications and pollution standards for discharge water are becoming more stringent, increasing the need for current AMD water treatment to further reduce total dissolved solids and sulfate levels below the values that can currently be achieved by the now commonly accepted methods of remediation. For example, in one planned AMD water remediation project the treated water will be used as makeup water to a power plant. In this case, total dissolved solids (TDS) must be reduced to below 330 ppm, SO₄⁻² to less than 60 ppm, and Ca⁺² below 50 ppm, and Fe, Mn, and Al must be reduced to less than 0.1 ppm each.

### SUMMARY OF THE INVENTION

In accordance with the invention, a method is provided for treating acid mine water wherein lime or other neutralizing agent is first used to neutralize the acid water and precipitate metals, treating the neutralized water in a clarifier to produce clarifier effluent having reduced dissolved solids, adding an oxidizing agent to the clarifier effluent to oxidize remaining dissolved metal species to form a clarifier effluent with suspended metal particles therein and treating the clarifier effluent via microfiltration to form a microfiltration filtrate having a reduced content of suspended particles. Microfiltration filtrate is then further purified by a reverse osmosis membrane system.

In other exemplary embodiments of the invention, a cartridge filter is employed upstream from the reverse osmosis station and downstream from the microfiltration unit. Additionally, scale control agents and the like can be fed to the system to prevent fouling of the reverse osmosis membranes. Especially efficacious are the phosphonate calcium sulfate control agents, which are fed to the RO (Reverse Osmosis) unit so as to inhibit the formation of calcium sulfate scale on RO membranes.

The invention will be further described in the following detailed description and accompanying drawings.

### BRIEF DESCRIPTION OF THE DRAWINGS

FIG. 1 is a process schematic showing one exemplary embodiment of the invention; and

FIG. 2 is a process schematic of one exemplary embodiment of the Reverse Osmosis (RO) system of the inventive method.

### DETAILED DESCRIPTION OF EXEMPLARY EMBODIMENTS

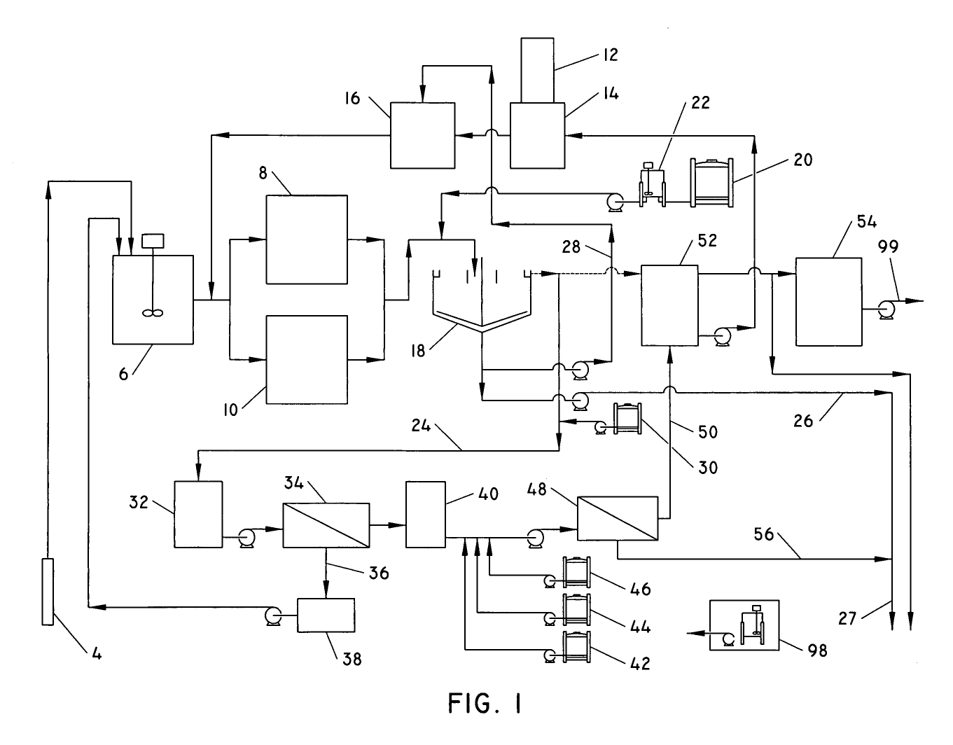

Turning to FIG. 1 of the drawings, there is shown a process for treating AMD water. As shown, AMD water is directed to a decarbonation/aeration tank 6 via a pump 4. In one exemplary embodiment, the decarbonation/aeration process consists of a tank 6 with volume sufficient to provide sufficient retention time. The tank has a surface aerator therein to provide air to oxidize iron. CO₂ is stripped off the AMD to reduce lime consumption.

Discharge from decarbonation/aeration tank 6 flows over an internal weir prior to entering a flow splitter wherein a lime sludge mixture is added from sludge densification tank 16 for neutralization of the water. Following lime addition, the flow is directed to the two parallel reaction tanks 8, 10. Each of these tanks is equipped with a surface aerator to provide sufficient oxygen transfer for further iron oxidation. Discharge from the tanks 8, 10 flows over an internal weir prior to entering a flume wherein the waters are combined with a polymer coagulant from source 20 and makeup water dilution station 22. As is conventional in the art, the clarifier influent flume and center well of clarifier 18 provide sufficient flocculation time for the polymer to promote particle agglomeration.

Effluent from the clarifier is directed in effluent line 24 to clarifier effluent tank 32. Solids that settle in the clarifier, forming sludge or underflow, are recycled to the sludge densification tank via line 28, or possibly pumped to a mine borehole or the like for disposal through line 26 and 27.

The lime system, in one exemplary embodiment, comprises a silo 12 and slaker 14 where water is introduced to provide a lime slurry. Additional water can be added to the slurry to provide about a 5-20% consistency lime slurry which overflows into the densification tank 16 where it is mixed with recycled sludge from the clarifier. This lime and sludge mixture is added to the AMD flow by gravity, following the decarbonation/aeration tank to neutralize acidity.

An oxidizing agent such as sodium hypochlorite is fed from tank 30 to the clarifier effluent upstream from clarifier effluent tank 32. This will help to ensure oxidation and removal in downstream microfilter 34 of the remaining Fe and Mn in the clarifier effluent since either of these metal species could be problematic in the reverse osmosis unit 48. The AMD from clarifier effluent tank 32 is directed via a pump to the microfiltration unit 34 wherein particulate matter larger than 0.1 μm will be retained by the MF membranes. Filtrate is directed to filtrate tank 40 and MF concentrate (reject) will travel through line 36 to sump 38 from which it will be recycled back to the inlet of the decarbonation tank.

Feed to the RO station 48 will be taken from the filtrate tank 40, pressurized, and sent to the RO machines. In one embodiment of the invention, about 30-80% of the RO feed will pass through the RO membranes resulting in low dissolved solids permeate or product water that, as shown, is directed to line 50 to effluent tank 52 and subsequently to treated water tank 54 where it is pumped through product line 99 for discharge or use, for example, as makeup water for a power plant or the like.

The reject or concentrate from the RO membranes, containing the rejected ions, is directed to line 56 and forwarded to waste line 27 which can be in communication with a borehole or other waste containment site.

In order to minimize fouling and scaling on the RO membranes, pH may be adjusted via addition of acid from acid tank 44 to the RO feed. Similarly, a dechlorination chemical, such as sodium bisulfite, may also be fed to the RO feed from source 42 to protect the membranes from the harmful effects of chlorine. Also, as shown, a skid feed 98 may be provided to provide a source of cleaning treatment for the RO unit with a mechanism for quickly connecting and disconnecting the unit to the RO feed.

In accordance with one embodiment of the invention, RO permeate water quality will have a maximum level of: 60 ppm SO₄⁻², 10 ppm silica, 50 ppm Ca⁺², 0.1 ppm Al, 0.1 ppm Fe, 25 ppm Mg, 0.1 ppm Mn and 300 ppm total dissolved solids.

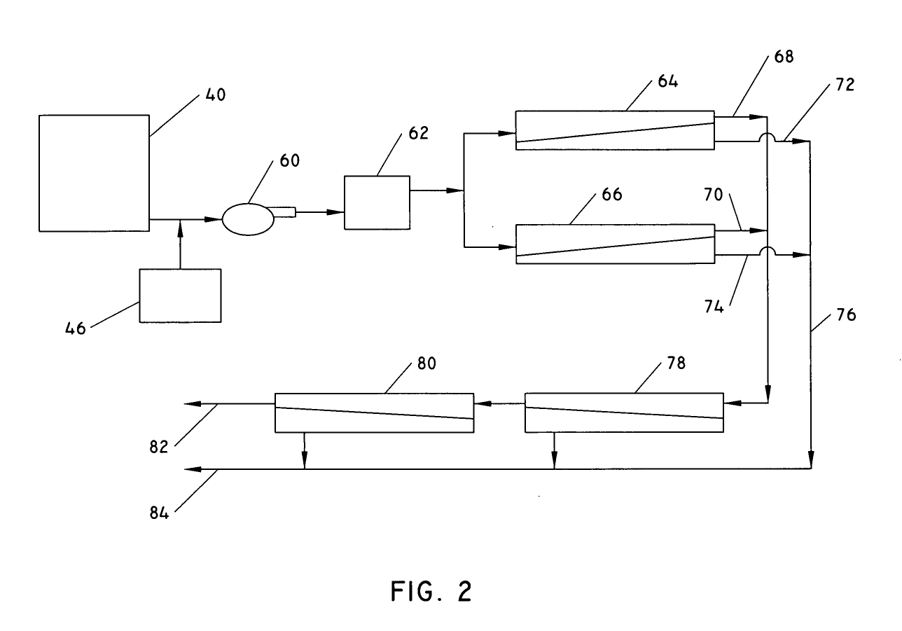

Turning now to FIG. 2, an exemplary embodiment showing the RO system of the process is depicted. Downstream from MF feed tank is a microfilter such as the type commercially available from Pall Corporation, East Hills, N.Y. These MF membranes may be of the type depicted for example in U.S. Pat. No. 6,254,773, the disclosure of which is incorporated by reference herein. The MF membranes generally comprise an assembly in an elongated housing having therein a plurality of discrete fiber bundle lengths disposed end to end in a series configuration. Each filter bundle length comprises a multiplicity of micro-porous polymeric hollow fibers of the type wherein feed to be filtered is fed to the outside of the fiber bundle and filtrate is extracted from one or both of the filtrate discharge ends of the fiber lumens. A bank or modules of these type of microfilters is provided by commercial suppliers, such as the aforementioned company. One particularly preferred microfiber system is available from Pall Corporation and comprises a plurality of “Microza” fiber modules. The preferred MF system will pass in the filtrate those particles having a size of about 0.5 μm or less, preferably 0.1 μm or less.

As shown in FIG. 2, filtrate from the MF unit is directed to filtrate tank 40 and directed by pump 60 through a cartridge filter 62 of the commercially available type. In this embodiment, the filter 62 will pass, as filtrate, particulate solids having a particle size of less than 1 μm. Upstream from filter 62, a RO antiscalant is fed to the water from source 46. The RO system depicted in the figure is a three-stage configuration with a first stage comprising parallel upstream RO units 64, 66. These RO units are preferably of the spiral wound membrane type available from GE Osmonics. As is known in the art, RO membrane separation is achieved when the osmotic pressure of the concentrated solution is exceeded by the pressure applied to the one side of the membrane elements that are usually provided in bundles. The membranes reject dissolved solids and let water pass through. The magnitude of pressure applied is a function of the pressure differential across the membranes, flow, and the total dissolved solids (TDS) content of the RO feed.

As shown, permeate from the upstream parallel RO units 64, 66 is directed through lines 72, 74 for conjoint flow through permeate line 76 which collects permeate from intermediate RO unit 78 and downstream RO unit 80 forming permeate exit line 84 that can lead for example into a treated water tank or other reservoir or process line such as shown in FIG. 1. Concentrate (reject) from the units 64, 66 is directed through lines 68, 70 as feed to intermediate RO unit 78 with concentrate (reject) from that unit used as feed to downstream unit 80. Concentrate from this 2-1-1 three-stage RO system is directed to line 82.

Treatment of AMD water with RO membrane technology is challenging. Particulate fouling from suspended solids, metal fouling from aluminum, iron, and manganese and mineral scale fouling from calcium sulfate are all problems that must be overcome in order to employ RO technology as part of the process. Without proper treatment and process control, the presence of any one of these fouling sources can affect performance, maintenance and overall RO membrane life.

As to the RO antiscalants that may be fed to the RO feedwater, we have found that calcium sulfate scale forming species are commonly encountered in AMD and must be properly treated to enhance RO membrane performance. Phosphonate antiscalants (including water soluble salts thereof) perform well in this regard. These compounds should be fed in an amount adequate to keep the membrane surfaces free of foulants. For example, the phosphonate antiscalant may be fed in an amount of about 0.1-50 ppm with a more preferred amount being between about 1-20 ppm. The phosphonate antiscalants are brought into contact with the RO membranes preferably by feeding them to the filtrate from the MF unit, but if the MF experiences calcium based scaling, the antiscalants may also be added prior to the MF.

Exemplary phosphonates have a carbon to phosphorous bond as shown in the following: 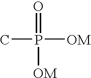
wherein M is a water soluble cation or H.

The preferred phosphonate, hexamethylene diamine-N,N, N′, N′-tetra(methylene phosphonic acid)-K salt form was tested in the field at a 2 ppm actives level used in the RO feed of AMD having a calcium sulfate concentration of about 6-8 times saturation.

### Pilot Studies

In order to assess the efficacy of proposed acid mine drainage systems in accordance with the invention, studies were undertaken with an abandoned eastern state location mine and its associated acidic, aqueous mine water. Prior to the commencement of the study, a clarification system had been installed in which the acid mine wastewater was pumped out of the mine, neutralized, and clarified to protect against environmental damage that could occur if the acidic mine water escaped directly from the mine.

Recent environmental regulations dictate that discharge from the mine wastewater should have reduced sulfate and total dissolved solids (TDS) standards respectively of less than 850 ppm sulfate and less than 2500 ppm TDS. Further, since the mine water is ultimately to be used as plant makeup water in a zero liquid discharge facility, water quality would have to be further improved to contain less than 300 ppm TDS, less than 60 ppm SO₄⁻², with Ca⁺² below 50 ppm and Fe, Mn, and Al each being below 0.1 ppm.

Samples of the eastern mine water were analyzed and found to be as follows:

| Constituent, mg/l except as noted | Average | Min | Max |
|---|---|---|---|
| pH, standard units | 4.2 | 2.8 | 6.5 |
| Specific Conductance, 25° C., μmhos | 4177 | 3630 | 6020 |
| Alkalinity, “P”, as CaCO₃ | 0.0 | 0.0 | 0.0 |
| Alkalinity, “M”, as CaCO₃ | <10.3 | 0.0 | <202 |
| Free Mineral Acidity, as CaCO₃ | 38.5 | 0.0 | 211.0 |
| Sulfur, Total as SO₄ | 2533 | 2220 | 3580 |
| Chloride as Cl | 59 | 37 | 103 |
| Hardness, Total, as CaCO₃ | 1228 | 1150 | 1580 |
| Calcium, Total as CaCO₃ | 777 | 715 | 967 |
| Magnesium, Total as CaCO₃ | 448 | 421 | 609 |
| Barium as Ba | 0.01 | <0.01 | 0.10 |
| Strontium as Sr | 3.5 | 2.9 | 5.2 |
| Lead, as Pb | <0.05 | <0.05 | <0.05 |
| Cadmium, as Cd | 0.02 | 0.02 | 0.02 |
| Copper, Total as Cu | <0.05 | <0.05 | <0.05 |
| Iron, Total as Fe | 298 | 169 | 372 |
| Sodium as Na | 450 | 332 | 908 |
| Potassium as K | 12.2 | 9.0 | 21.0 |
| Aluminum, Total as Al | 1.4 | 0.4 | 4.7 |
| Manganese, Total as Mn | 7.2 | 4.7 | 8.7 |
| Zinc, as Zn | 0.21 | 0.12 | 0.25 |
| Nitrate, as NO₃ | <3 | <1 | <10 |
| Phosphate, Total, as PO₄ | <0.4 | <0.4 | <0.4 |
| Silica, Total as SiO₂ | 14.8 | 12.7 | 18.0 |
| Fluoride, as F | 0.6 | <0.4 | 1.3 |
| TOC, as C | 2.9 | <1.0 | 133.0 |
| Turbidity, NTU | 444 | 4 | 1110 |
| Total Dissolved Solids, ppm (calc) | 3812 | 3376 | 5508 |

The analysis indicated that the AMD water from the mine was characterized by relatively low pH (2.8 to 6.5), high sulfate (2,220 to 3,580 ppm) and total dissolved solids (3,376 to 5,500 ppm), and high levels of metals, primarily iron (169 to 372 ppm), aluminum (0.4 to 4.7 ppm), and manganese (4.7 to 8.7 ppm).

The existing treatment system utilized a clarifier and associated equipment to aerate and raise the pH of the wastewater with lime, yielding a reduction of total suspended solids (TSS) to an average of 35 ppm with oxidation and subsequent precipitation and removal of Fe and Mn to levels of 3.0 and 2.0 ppm, respectively.

Two alternative treatment programs were envisioned for the pilot study. In one program, the clarifier effluent was to be diverted to a new clarifier effluent tank with sodium hypochlorite being fed thereto to assure oxidation and removal of iron and Mn in downstream microfilters. Reverse osmosis (RO) was to be employed downstream from the microfiltration units.

The other proposed alternative system was to take the clarifier effluent and use it as feed to a sand filter and then to an RO system.

The proposed systems can be summarized as follows:

| System 1 | System 2 |
|---|---|
| Existing Clarifier | Existing Clarifier |
| Sand Filter | Microfiltration System |
| RO | RO |

With regard to System 1, a sand based continuous backwash upflow filter was employed downstream from the clarifier. The filter produced a continuous filtrate stream and a continuous concentrate stream and did not need to be shut down for backwash cycles. Sand was backwashed internally in the filter tank using filtered water that was redistributed back on top of the sand bed.

In System 1, the filtrate from the sand filter was fed to a multimedia (MMF) type cartridge filter with filtrate then fed to a RO (Reverse Osmosis) membrane system. The RO membrane system consisted of three spiral wound hollow fiber membranes available from the GE Osmonics Division.

Standard procedure was to flush the RO system with RO permeate whenever it would shut down. The RO feed was dosed with sodium bisulfite to scavenge residual chlorine and an antiscalant was fed upstream from the RO system in order to prevent calcium sulfate scaling.

The following RO parameters were measured and logged: temperature, prefilter inlet pressure, concentrate pressure, prefilter outlet pressure, feed pressure, feed flow, permeate flow, concentrate flow, feed conductivity and permeate conductivity.

The RO system was always run at a set recovery which was adjusted by regulating the permeate and concentrate flow rates with adjustments to the feed pump discharge valve and the concentrate back pressure valve. No subsequent adjustments to pressure were made once the concentrate and permeate flow rates were set for a certain recovery. Fouling was therefore monitored by observing increases in pressure, at a given permeate flow rate and recovery rate. If there is no major change in temperature or feed TDS (measured in this test as conductivity), the pressure should remain constant.

During the course of the test, the RO was run at different recoveries. Pursuant to verifying the full-scale equipment's design recovery of 65%, the target or goal was to achieve continuous steady state operation at 75% recovery. It is standard practice to exceed the design performance of the commercial process during a pilot. This is especially important in wastewater and/or streams where the membranes are at risk for mineral scaling (as is the subject stream), in order to establish some margin between design operating parameters and critical levels. Hence, the pilot was also run at 75% recovery.

In System 2, the sand filter and multimedia filter were not used. Instead, in its place upstream from the RO membrane system, a microfiltration (MF) unit was used. This MF unit was a hollow fiber MF module. Physical characteristics of the membrane are described below

An ancillary pretreatment system was installed upstream of the MF system. This equipment supplemented the basic MF system with the capacity to provide oxidation with sodium hypochlorite.

| Microfilter Specification | |
|---|---|
| nominal pore size | 0.1 μm |
| membrane material | PVDF |
| flow direction | outside/in |
| maximum chlorine | 5000 mg/L |
| maximum caustic | 1 N |
| maximum acid | 1 N |
| pH operating range | 1-10 |

The MF media was supplied in modules using MF class hollow fiber PVDF membrane, 0.1 micron pore size, TMP Trans Membrane Pressure) ˜2.5 bar, pH range 1-10 operational.

Pilot Run Conclusion

The overall evaluation of pretreatment processes, post clarifier and pre-RO, led us to select System 2. As we experienced, the clarifier effluent was subject to carry over of suspended solids, as well as unique, high concentration dissolved chemistry. Specifically, dissolved metals, such as iron and manganese, present in the effluent were detrimental to the RO membranes. When soluble in the clarifier effluent, the metals were not removed by conventional sand filtration since they are not particles. With oxidation, these species precipitate but are not large enough to be captured effectively by a sand and/or multimedia filter. Microfilters (MF) provided a more positive protection for the RO membranes. Since space may be of concern in many applications, the smaller spatial requirements of the MF systems is also an advantage.

Except for the need to conduct frequent cleanings, the MF system demonstrated stable operation at proposed operating conditions when the upstream clarification process was in control, consistently protecting the RO from potentially catastrophic membrane fouling. We did find that with fouling from suspended particulate inhibited by the MF, scaling of the RO membranes presented a potential problem. However, the use of phosphonate scale control agents (e.g., hexane tetramethylenephosphonic acid), were found effective in inhibiting membrane scaling from CaSO₄ at RO recovery rates of about 65% and greater.

Whereas we have shown and described herein certain embodiments of the present invention, it is intended that these be covered as well as any change or modification therein which may be made without departing from the spirit and scope of the invention.

What is claimed is:

1. A method of treating acid mine wastewater of the type having suspended and dissolved solids and dissolved metal species therein wherein said metal species comprise heavy metals and Al, Mn, Fe or combinations thereof, said method comprising
a) adding lime or other neutralizing agent to said water to neutralize said water;
b) clarifying said neutralized water in a clarifier, thereby resulting in a clarifier effluent having reduced suspended solids;
c) adding an oxidizing agent to said clarifier effluent to oxidize said dissolved metal species thereby forming clarifier effluent with suspended metal particles therein;
d) subjecting said oxidized clarifier effluent having suspended metal particles therein from c) to a microfiltration (MF) process whereby said clarifier effluent with suspended metal particles is brought into contact with a microfilter membrane having a pore size of 0.5 μm or less to thereby form a MF filtrate having a reduced content of suspended metal particles therein; and
e) contacting said MF filtrate with a reverse osmosis membrane operating under reverse osmotic pressure conditions to reduce dissolved solids content of said MF filtrate thereby forming an RO permeate.

2. Method as recited in claim 1 wherein said method comprises after said step d) and prior to said step e), the additional step of contacting said MF filtrate with a filter media having a pore size of about 1 μm.

3. Method as recited in claim 1 further comprising contacting said RO membrane with a scale control agent.

4. Method as recited in claim 3 wherein said acid mine water comprises ions in sufficient quantity to form scale on surfaces in contact with said water.

5. Method as recited in claim 4 wherein said acid mine wastewater comprises Ca ions and sulfate ions in sufficient quantity to form calcium sulfate scale on said surfaces in the absence of treatment with said scale control agent.

6. A method as recited in claim 5 wherein said scale control agent is a phosphonate having a carbon to phosphorus bond with the formula 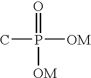
wherein M is a water soluble cation or H.

7. A method as recited in claim 6 wherein said phosphonate comprises hexamethylenediaminetetraphosphonate or salt thereof.

8. A method as recited in claim 7 wherein said antiscalant is added before and/or after said MF filtrate.
